(19) United States
(12) Patent Application Publication
(10) Pub. No.: US 2015/0083247 A1
(43) Pub. Date: Mar. 26, 2015

(54) Flow Control Components With Traceable Indicia

(71) Applicant: Richard Schroder, Lebanon, OH (US)

(72) Inventor: Richard Schroder, Lebanon, OH (US)

(21) Appl. No.: 14/032,970

(22) Filed: Sep. 20, 2013

(51) Int. Cl. F16K 51/00; F16K 7/12

(52) U.S. Cl. CPC F16K 51/00; F16K 7/12
USPC 137/560

(57) ABSTRACT

A valve diaphragm is provided with indicia of origin, batch number, date of manufacture and other information. Critical indicia are disposed on outwardly projecting tabs that can be see when the diaphragm is operatively mounted in the valve. Indicia may be provided on elastomeric and non-elastomeric portions of the diaphragm.

### CROSS REFERENCE TO RELATED APPLICATION

The present U.S. Non-Provisional Patent Application is related to U.S. Non-Provisional Application for patent Ser. No. 12/764,079 filed Apr. 20, 2010 and entitled “Molded Flow Control Components With Traceable Indicia”, and is incorporated herein by reference in its entirety.

### BACKGROUND OF THE INVENTION

1. Field of the Invention

The present marking system relates to flow control equipment and more particularly to the marking of valve diaphragms and other components used to contain and control the flow of process fluids in the sanitary products industry. These components are typically used in the production of pharmaceutical, food and dairy products.

2. Related Art

Quality control in the pharmaceutical, food and dairy industries requires specialized and thorough tracing of all materials and process components used in manufacture (traceability). This traceability requirement extends to the production apparatus and includes both original equipment and replacement parts. To ensure consumer safety, it is important to have complete records of the composition of all components that come into contact with the food, dairy, and pharmaceutical process streams and to be able to trace or determine when and where each of these components was made. Food, dairy and pharmaceutical ingredients flow through a multiplicity of valves during a process run. Typically, the valves are provided with diaphragms that come into direct contact with the ingredients in the process stream. The diaphragms are subject to wear and are replaced at scheduled intervals.

In the past, certificates indicating date and location of manufacture, batch number, composition and other particulars have been packaged with the valve diaphragms. However, these data sheets usually become separated from the diaphragms when the diaphragms are installed in the valves. Although records of each diaphragm and its location in the complex piping system are normally kept, during installation, parts of differing origins and materials sometimes may inadvertently become mixed together and traceability is lost in the process. During periodic quality control reviews or inspections, it can be difficult to connect a particular diaphragm with its data sheets even if time and effort has been spent entering identifying information in the process records. Operator errors are difficult to track and parts are sometimes misidentified. Also if there is a defective diaphragm or group of diaphragms, a recall may become necessary.

Up to this time, because markings on the diaphragms have been limited to the year and month of manufacture, the diaphragm manufacturer might have to recall several batches in the absence of a clear association between the defective items and their corresponding certificates, since there is an absence of batch specific information on the diaphragms themselves. In addition, if a particular lot of a diaphragm assembly's materials of construction is found to contaminate a food or drug product, knowing the exact location of the affected parts is essential for subsequent investigations to determine the impact on the product and to assure consumer/patient safety. The present marking system is intended to alleviate these shortcomings and provide complete batch specific identification directly on the diaphragms or other molded process components so that, simply by looking at the part, the operator or process engineer may know the exact provenance of the part without the aid of paperwork for the entire lifetime of the part.

### SUMMARY OF THE INVENTION

In a diaphragm designed for installation in a valve or a comparable flow control assembly, an improvement comprising a plurality of indicia outwardly visible on the diaphragm when installed in the flow control assembly; said indicia providing with respect to said diaphragm identification of at least the manufacturer, month and year of production and batch number. Preferably, the indicia include a first pointer indicating the month of manufacture and a second pointer indicating the batch number.

### BRIEF DESCRIPTION OF THE DRAWINGS

FIG. 1 is an exploded view of a valve assembly including a first diaphragm;

FIG. 2 is a sectional view of a valve body with a second diaphragm mounted thereon;

FIG. 3 is a planar view of the first or second diaphragm bearing traceable indicia;.

FIG. 4 is a fragmentary view of the first or second diaphragm with one surface bearing traceable indicia; and

FIG. 5 is a fragmentary view of the first or second diaphragm with an opposite surface bearing traceable indicia.

### DETAILED DESCRIPTION OF EXEMPLARY EMBODIMENTS OF THE INVENTION

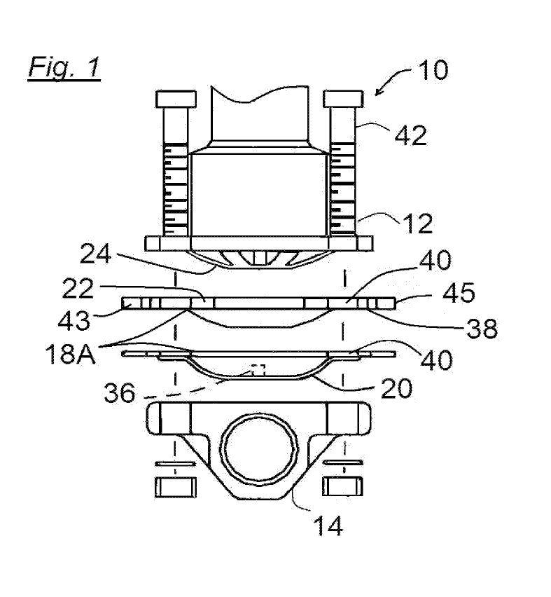

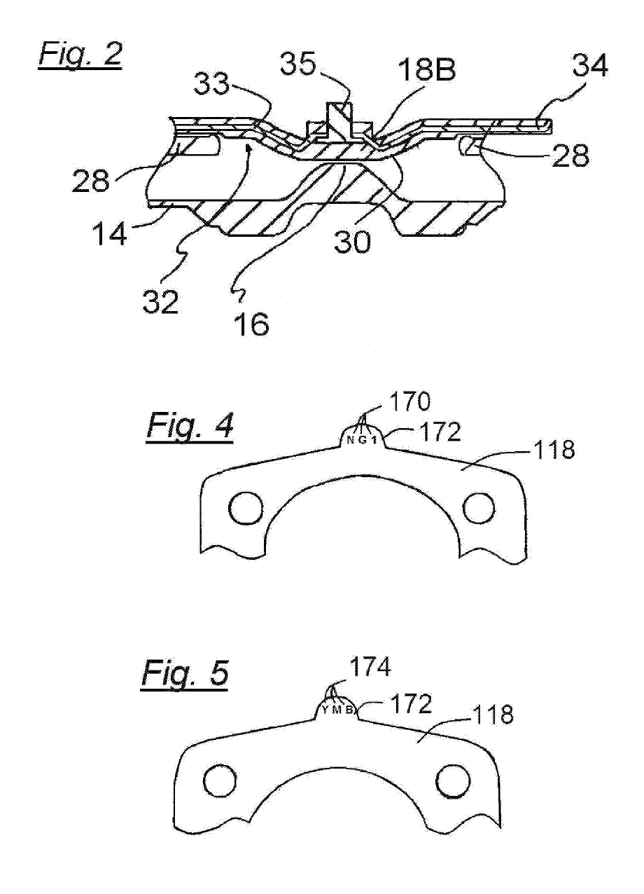

As illustrated in FIG. 1, the flow control assembly may be a valve, generally designated 10. The valve typically includes a bonnet 12, which contains the mechanical means of opening and closing the valve, and a body 14, which may house a two-piece diaphragm 18A. The bonnet moves the diaphragm to control the flow of a process stream though the valve in a manner well known in the art. The diaphragm 18A may be formed with a non-elastomeric facing piece or weir 20 that contacts the process stream and with an elastomeric backing member 22 that distributes a closing force exerted by a compressor 24 against the weir 20. The backing member 22 may be formed from EPDM, and the weir 20 may be formed from fluoropolymers or other plastics appropriate to the process. Connecting hardware 36, such as a stud or threaded socket, may be molded into a central area of the weir 20 and attached to the compressor 24 that moves the diaphragm 18A towards and away from the valve seat 16 (FIG. 2).

As illustrated in FIG. 2, the diaphragm 18B may be formed by means common to those skilled in the art into a configuration that operatively conforms to a diaphragm-receiving area or land 28 on the valve body 14. A process-facing surface 30 of the diaphragm 18B spans a diaphragm-receiving opening 32 in the valve body 14 and extends in overlying relation to the land 28 surrounding the opening 32. The diaphragm 18B may be molded from material such as EPDM, and provided with an intermediate reinforcing layer 33. Connecting hardware 35, such as a stud or threaded socket, may be molded into or otherwise secured to a central area of the diaphragm 18B and attached to a compressor 24 (FIG. 1) that moves the diaphragm towards and away from the valve seat 16.

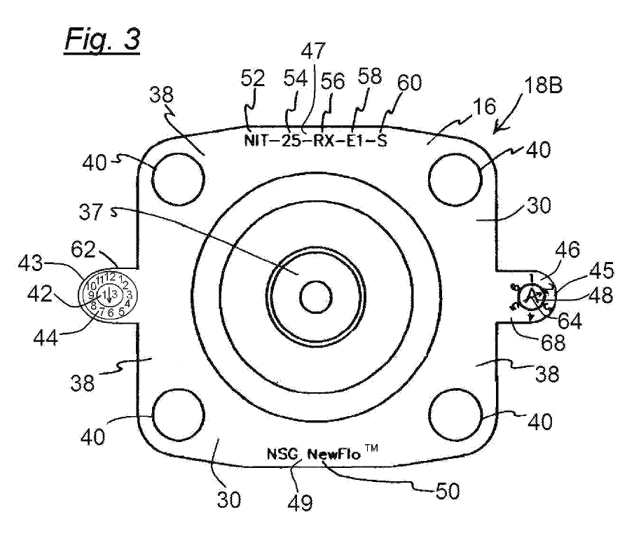

As illustrated in FIGS. 1 and 3, the diaphragm typically includes an anchoring area 38 formed with bores 40 through which connecting hardware 42 may extend to draw the valve bonnet 12 and body 14 together, the diaphragm being sandwiched therebetween. Tabs 43, 45 may extend outwardly from opposing sides of the anchoring area 38 and may be visible when the valve is assembled. One of the tabs 43 may indicate the year 42 and month 44 of manufacture. The other tab 45 may indicate the batch or lot number 46 and manufacturer code 48 of the diaphragm. Preferably, 12 months 44 appear in surrounding relation to the year of manufacture 42 on one tab 43, and a first pointer 62 is provided thereon adjacent to the year to indicate the particular month of manufacture. Likewise, a plurality of batch numbers 46 appear on the other tab 45 in surrounding relation to the manufacturer code 48, and a second pointer 64 adjacent to the manufacturer code indicates the particular batch from which the diaphragm originates. Preferably, the foregoing indicia 42-48 and pointers 62,64 are molded or stamped into the diaphragm, and the positions of the pointers 62, 64 are determined by employing a rotatable mechanism within the molding or stamping apparatus (not shown).

As further indicated in FIG. 3, the anchoring area 38 may include areas or strips 47, 49 disposed between the bores 40 adjacent to opposing edges of the diaphragm. One of the strips 47 may provide a part number for the diaphragm, and the part number may comprise a style code 52, a size code 54, a grade code 56, a composition code 58, and/or a construction code 60. The other strip 49 may bear the trademark 50 of the diaphragm. Like the batch, manufacturer, and date information 42-48 on the tabs 43, 45, the part number and trademark 50-60 on the strips 47,49 are preferably molded or stamped into the surface of the diaphragm.

FIGS. 4 and 5 illustrate an alternative marking system suitable for a diaphragm 118 formed from a non-elastomeric material capable of retaining the impression of a stamp. As illustrated in FIG. 4, manufacturer/material information 170 where, for example, ‘N’ is the first initial of the manufacturer and ‘G1’ is a material designation, may be encoded on one surface of an outwardly extending tab 172. As illustrated in FIG. 5, batch specific information 174, where, for example, ‘Y’ is the year, ‘M’ is the month of manufacture, and ‘B’ is the assembly batch number in the indicated month and year is stamped on the opposite surface of the tab 172. In this manner, the foregoing information is readable when the valve is fully assembled with the diaphragm in place. This system is useful when marking the diaphragm inside the confines of the processing area of the valve might interfere with the performance and sealing properties of the diaphragm or other process component.

Other diaphragms besides valve diaphragms used in the food, dairy, and pharmaceutical industries could be similarly marked, for example pump diaphragms. Other seals and elastomeric valves and/or their components could also be similarly marked. Flow control components used in other industries may also benefit from this marking method. Although not limited by this, this invention incorporates indexable features (herein shown as pointers) that designate the month of manufacture and the batch number of the diaphragm assembly on the part itself as used in sanitary valves and other molded components for the food, dairy and pharmaceutical industries. It alternatively may consist of a stamped-in batch index code that also provides this same information on other food, dairy, and pharmaceutical components made of materials that are able to retain such stamped impressions.

1. In a diaphragm designed for installation in a flow control assembly, an improvement comprising a plurality of indicia outwardly visible on said diaphragm when installed in said flow control assembly, said indicia providing with respect to said diaphragm identification of at least the manufacturer, month and year of production and batch number.

2. The diaphragm according to claim 1, wherein said indicia are provided on first and second tabs projecting from said diaphragm.

3. The diaphragm according to claim 2, wherein the first tab displays a year of manufacture, numbered months surrounding said year of manufacture and a first pointer adjacent to said year of manufacture indicating the month of manufacture.

4. The diaphragm according to claim 1, wherein the second tab displays a manufacturer code, numbered batches surrounding said manufacturer code and a second pointer adjacent to said manufacturer code.

5. The diaphragm according to claim 1 wherein additional indicia are provided on opposing sides of the diaphragm adjacent to outer edges thereof.

6. The diaphragm according to claim 5, wherein a part number for the diaphragm is provided on one side thereof, said part number comprising style, size, grade and composition codes

7. The diaphragm according to claim 6, wherein one or more trademarks for the diaphragm is provided on the other side thereof.

8. The diaphragm according to claim 1, wherein said indicia are provided on opposing surfaces of a tab projecting outwardly from said diaphragm.

9. The diaphragm according to claim 8, wherein manufacturer and material indicia are provided on one surface of said tab and batch and date of manufacture indicia are provided on the opposing surface of said tab.

10. The diaphragm according to claim 9, wherein said indicia are stamped into the diaphragm.

11. The diaphragm according to claim 1, wherein the indicia are molded into the diaphragm.
